(19) United States
(12) Patent Application Publication
(10) Pub. No.: US 2011/0265357 A1
(43) Pub. Date: Nov. 3, 2011

(54) FOLDABLE GREETING CARD

(76) Inventors: Wan-Mei Wong, Hong Kong (HK); Eva Ng, Hong Kong (HK)

(21) Appl. No.: 12/770,494

(22) Filed: Apr. 29, 2010

(51) Int. Cl. G09F 1/04

(52) U.S. Cl. 40/124.06; 40/124.09; 40/124.08

(57) ABSTRACT

A foldable greeting card (10) movable from a fully folded position to a fully unfolded position, comprising: three longitudinal folds (11, 13, 14) equally spaced apart; a lateral fold (12) intersecting the longitudinal folds to form eight card sections (21, 22, 23, 24, 25) arranged in four columns and two rows, the card sections (21, 22, 23, 24, 25) having a first side and a second side; wherein on the first side of the card sections: a card section (21) at a second column of a second row is a front outer cover having a first greeting message (30) when the card (10) is in the fully folded position; a card section (25) at a first column of the second row is a rear outer cover when the card (10) is in the fully folded position; card sections (22) at the first and second columns of the first row are exposed to present a second greeting message (31); card sections (23) at third and fourth columns of the first and second rows are exposed to present a third greeting message (32); wherein on the second side of the card sections, all the card sections (24) are exposed to present a fourth greeting message (33) when the card (10) is in the fully unfolded position.

### TECHNICAL FIELD

The invention concerns a foldable greeting card.

### BACKGROUND OF THE INVENTION

Greeting cards have been used for hundreds of years. Typically, they are in the form of an illustrated folded card featuring an expression of sentiment. Usually the greeting card is removed from an envelope and unfolded by the recipient to reveal the expression of sentiment written by the sender.

There is a desire for a greeting card that is modern, innovative and generates a sense of increased excitement when the greeting card is opened by the recipient.

### SUMMARY OF THE INVENTION

In a first preferred aspect, there is provided a foldable greeting card movable from a fully folded position to a fully unfolded position, comprising:
three longitudinal folds equally spaced apart;
a lateral fold intersecting the longitudinal folds to form eight card sections arranged in four columns and two rows, the card sections having a first side and a second side;
wherein on the first side of the card sections:
   a card section at a second column of a second row is a front outer cover having a first greeting message when the card is in the fully folded position;
   a card section at a first column of the second row is a rear outer cover when the card is in the fully folded position;
   card sections at the first and second columns of the first row are exposed to present a second greeting message;
   card sections at third and fourth columns of the first and second rows are exposed to present a third greeting message;
wherein on the second side of the card sections, all the card sections are exposed to present a fourth greeting message when the card is in the fully unfolded position.

The fourth greeting message may be larger in size than the third greeting message, the third greeting message is larger in size than the second greeting message, and the second greeting message is larger in size than the first greeting message.

An expression of sentiment for the card may be any one from the group consisting of: birthday, anniversary, wedding, farewell, get well, congratulations, friendship, retirement, birth of baby, love, Valentine's day, humor, Christmas, graduation, and thank you.

The greeting messages may be messages about a celebrity, and the fourth greeting message is a poster image of the celebrity.

The card may further comprise at least another lateral fold and/or at least another longitudinal fold to form at least sixteen card sections.

The card may be in the form of a paper bag.

The card may further comprise transparent sleeves on each card section for receiving a photo.

The card may be made of fabric and further comprises handles.

The card may further comprise pop up elements that are raised from the surface of the card.

### BRIEF DESCRIPTION OF THE DRAWINGS

An example of the invention will now be described with reference to the accompanying drawings, in which:

FIG. 1 is a series of images depicting the unfolding of the card in accordance with a preferred embodiment of the present invention;

FIG. 2 is a plan view of a front side of a sheet of paper indicating sections of the card in accordance with a preferred embodiment of the present invention;

FIG. 3 is a plan view of a rear side of the paper of FIG. 2;

FIG. 4 is a series of images depicting the unfolding of a Birthday card in accordance with an embodiment of the present invention;

FIG. 5 is a series of images depicting the unfolding of a Wedding card in accordance with an embodiment of the present invention;

FIG. 5 is a series of images depicting the unfolding of a Valentine's Day card in accordance with an embodiment of the present invention;

FIG. 7 is a series of images depicting the unfolding of another Valentine's Day card in accordance with an embodiment of the present invention;

FIG. 8 is a series of images depicting the unfolding of a card in the form of a paper bag in accordance with an embodiment of the present invention;

FIG. 9 is a series of images depicting the unfolding of a card with transparent sleeves on card sections to hold photos in accordance with an embodiment of the present invention;

FIG. 10 is a series of images depicting the unfolding a card made from fabric and having handles in accordance with an embodiment of the present invention; and

FIG. 11 is a series of images depicting the unfolding a card with three dimensional pop-up elements.

### DETAILED DESCRIPTION OF THE DRAWINGS

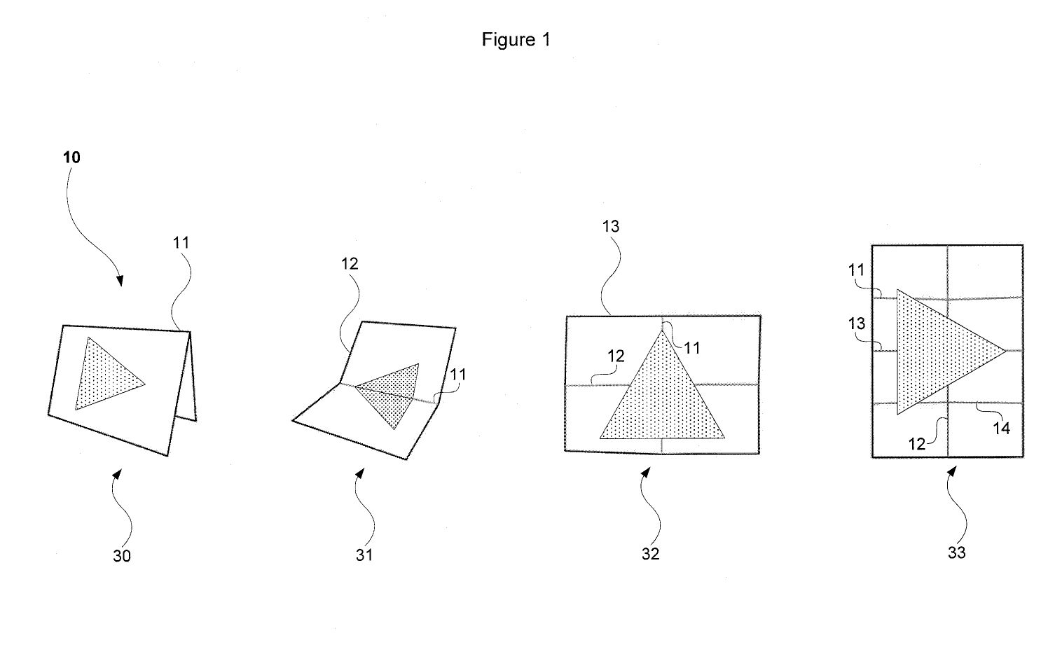

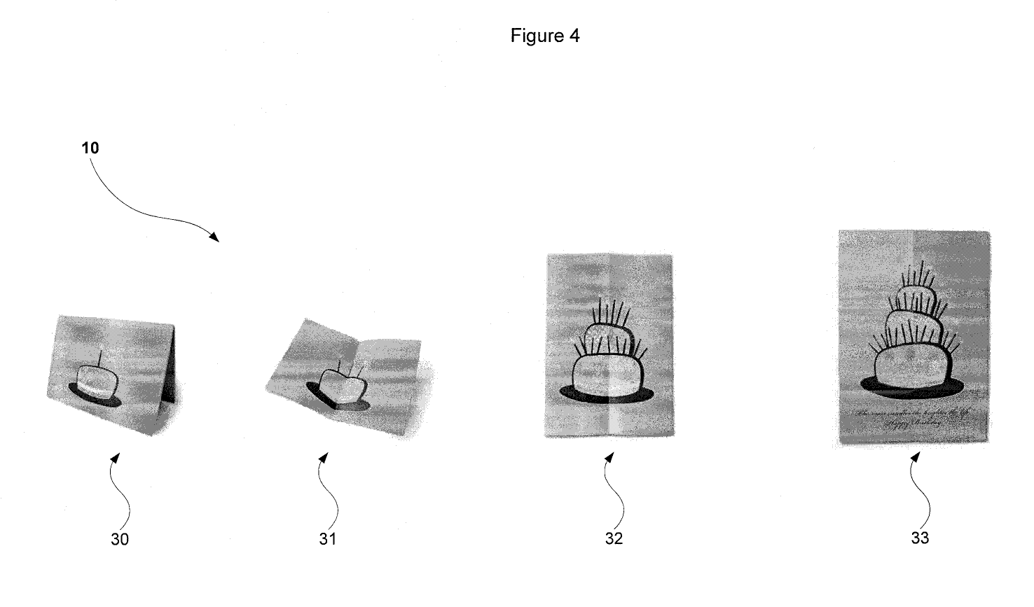

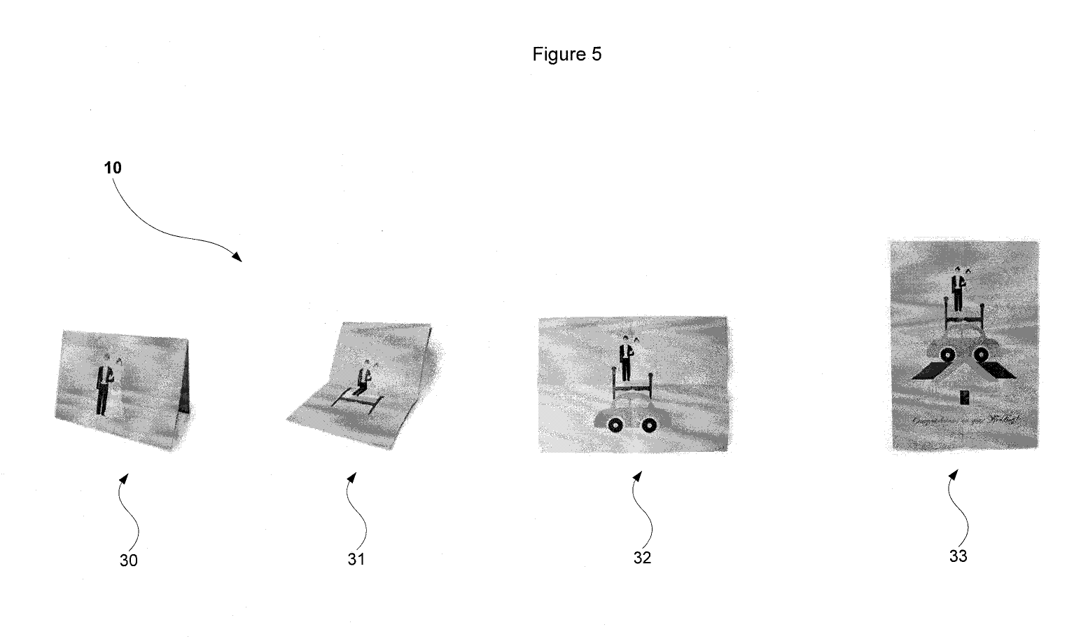

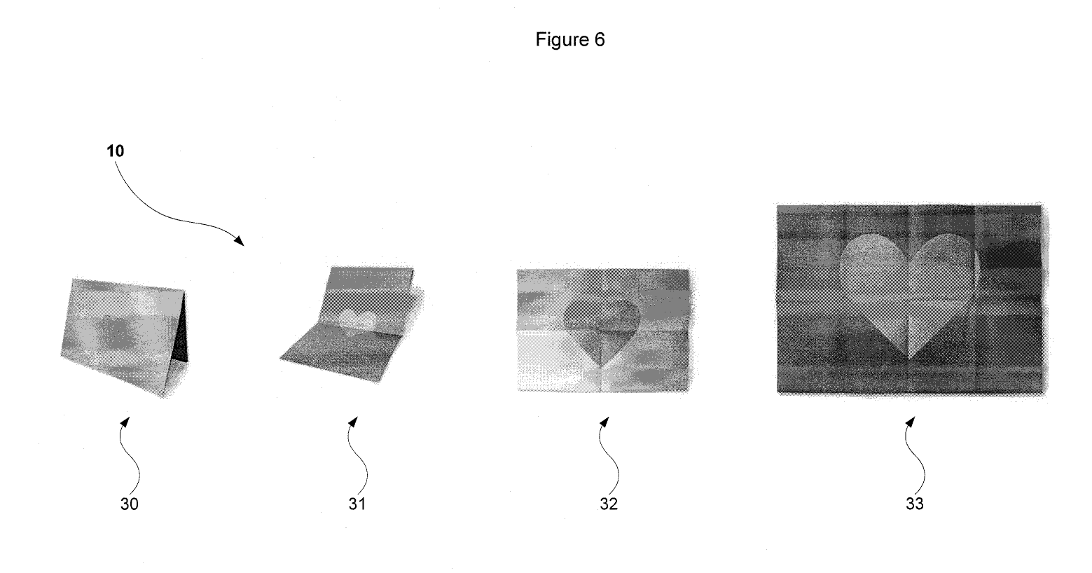

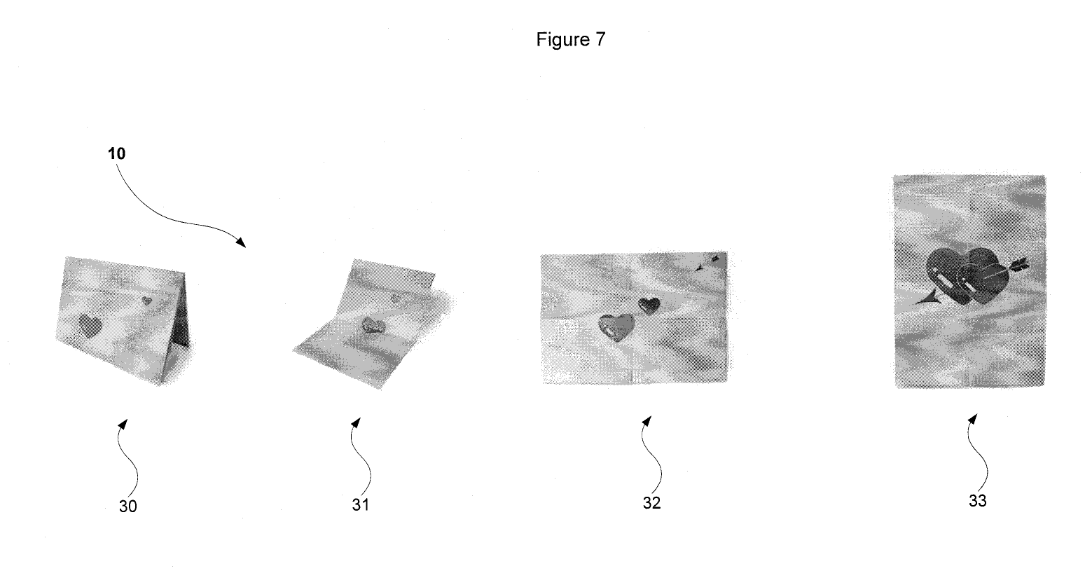

Referring to FIGS. 1 and 4 to 7, initially the card 10 appears as a typically sized greeting card in the fully folded position. The card 10 is usually sent to the recipient in a standard envelope. The recipient of the card 10 is generally unaware that the card 10 possesses several unfolding steps to reveal at least four greeting messages 30, 31, 32, 33. The front cover of the card 10 shows a first greeting message 30. The total surface area available for the first greeting message 30 is 21 cm length by 14.9 cm width.

Next, the card 10 is unfolded from the right side about a fold line 11 on the left side of the card 10 to reveal the second greeting message 31. The total surface area available for the second greeting message 31 is 21 cm length by 29.1 cm width.

Next, the card 10 is unfolded from the bottom side about a fold line 12 on the top side of the card 10 to reveal the third greeting message 32. The total surface area available for the third greeting message 32 is 42 cm length by 29.1 cm width.

Lastly, the card 10 is unfolded from the right side about a fold line 13 on the left side of the card 10 to reveal the fourth and final greeting message 33. The card 10 is now in the fully unfolded position. The total surface area available for the fourth greeting message 33 is 42 cm length by 59.2 cm width.

The unfolding process of the card 10 provides a kind of manual animation in a predetermined sequence. The recipient is lead through a series of greeting messages 30, 31, 32, 33 which offer a sense of excitement and curiosity by incrementally revealing the greeting messages 30, 31, 32, 33. Also, since the viewable surface area of the card 10 increases at each unfolding step, more imagery or textual information is able to be printed on it.

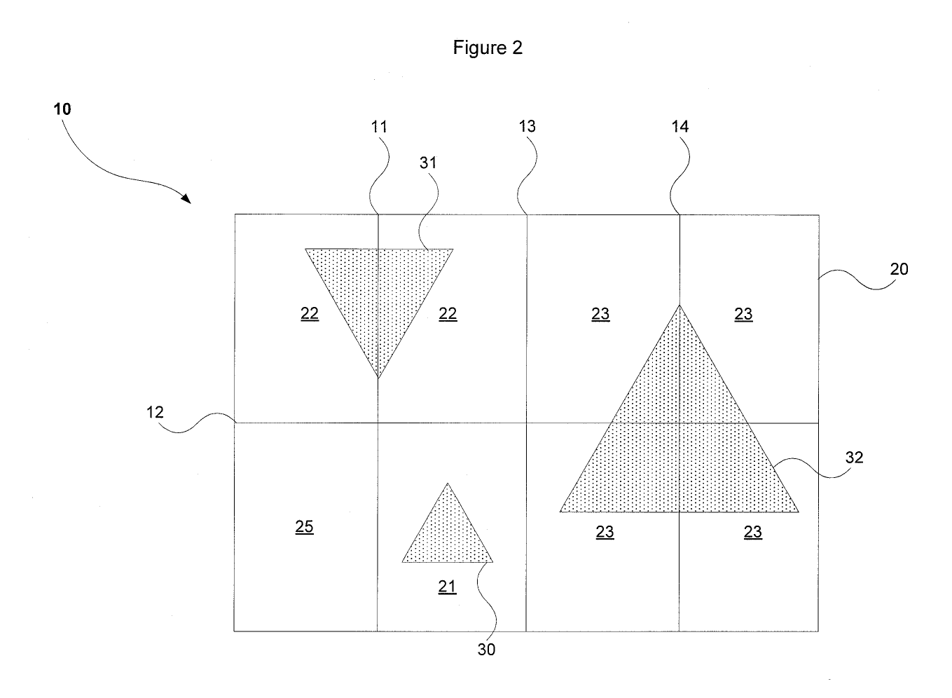

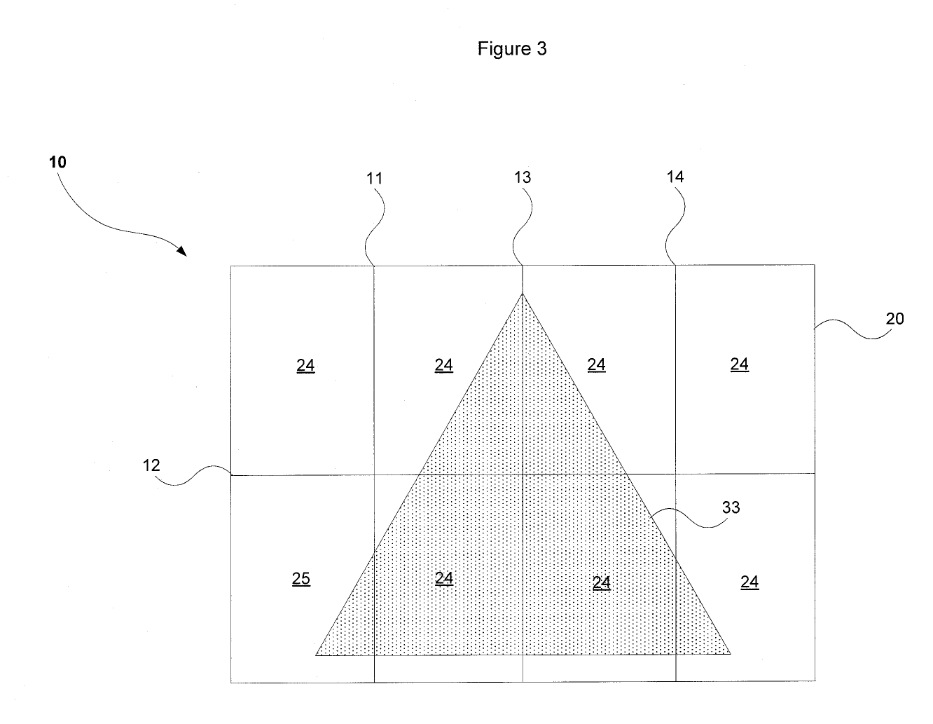

Referring to FIGS. 2 and 3, to make the card 10, the greeting messages are printed in a single printing step on a single sheet of paper 20 having the dimensions of 42 cm length and 29.1 cm width. The sheet of paper 20 has three vertical fold lines equally spaced apart and a central horizontal fold line. This forms eight distinct sections 21, 22, 23, 24, 25 on the paper. Each section is delineated by the fold lines 11, 12, 13, 14 and edges of the sheet of paper 20. The size of each section is approximately 21 cm length by 14.9 cm width. The first greeting message 30 uses a total surface area of one section 21. The second greeting message 31 uses a total surface area of two sections 22. The third greeting message 32 uses a total surface area of four sections 23. The fourth greeting message 33 uses a total surface area of eight sections 24. If a greeting message 31, 32, 33 using multiple sections for the total surface area, the greeting message 31, 32, 33 may span across some or all the sections.

On the single sheet of paper 20, the first greeting message 31 is oriented on the section 21 on the front side of the second column of the second row right side up. The second greeting message 31 is oriented on two sections 22 on the front side of the first and second columns of the first row upside down. The third greeting message 32 is oriented on four sections 23 on the front side of the third and fourth columns of the first and second rows right side up. The fourth greeting message 33 is oriented on all eight sections 24 on the rear side of the first, second third and fourth columns of the first and second rows right side up. A credits page may be located on a section 25 on the front side of the first column of the second row right side up. The credits page contains information about the card 10 and the manufacturer of the card 10.

The greeting card 10 may be printed with a background colour and also text and images. After the printing is completed, the fold lines 11, 12, 13, 14 are formed. A vertical centre fold 13 is formed and a horizontal centre fold 12 is formed. Finally, a third vertical fold 11, 14 is formed which in turn creates a typically sized greeting card 10 in the fully folded position. Different effects may be printed onto the card 10, for example, Flocks, glitter, UV coating, or foiling. Die-cutting may be used on the card 10 so that different shape cut-outs may be made in the card 10.

The expression of sentiment for the card 10 can be: birthday, anniversary, wedding, farewell, get well, congratulations, friendship, retirement, birth of baby, love, Valentine's day, humor, Christmas, graduation, and thank you.

The greeting messages 30, 31, 32 can be messages about a celebrity, and the fourth greeting message 33 is a poster image of the celebrity.

In another embodiment, the fourth greeting message 33 is a calendar poster. The greeting messages 30, 31, 32 can be messages about dates and/or events.

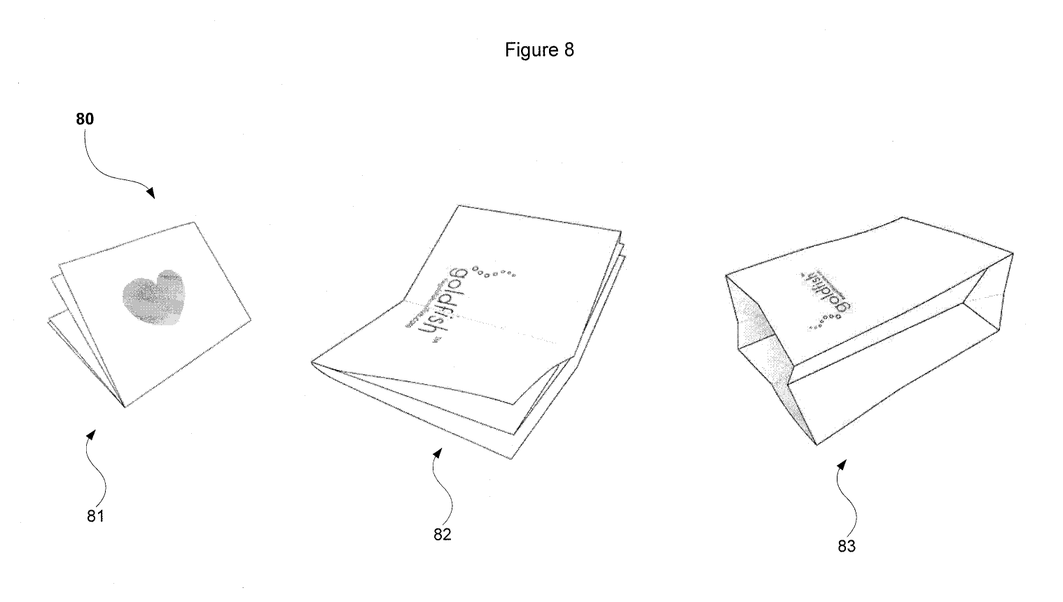

Referring to FIG. 8, another embodiment depicts a card 80 which unfolds into the form of a paper bag with a greeting message. In contrast to the other embodiments, a large paper bag 83 is used instead of a large piece of paper. The paper bag is printed with a message. The paper bag is folded 82 like the other embodiments until it is the same size as an ordinary card 81.

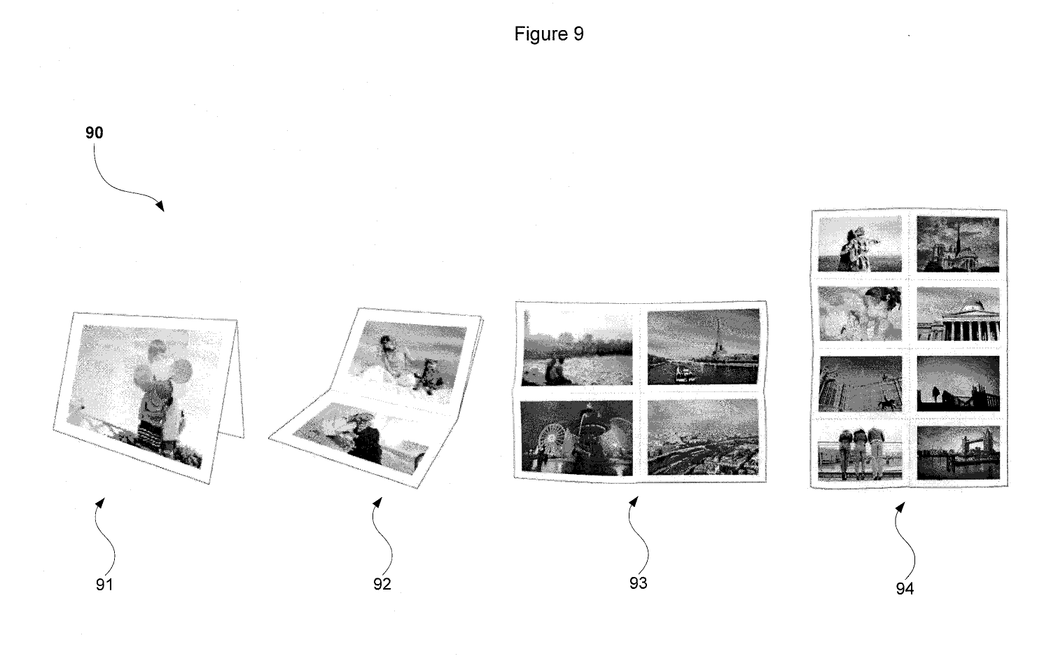

Referring to FIG. 9, another embodiment depicts a card 90 which holds a photo on each section. Each section has a transparent sleeve to receive a photo. A photo or other printed matter is slid into the sleeve and held in place between the sleeve and the surface of the card. Initially in fully folded position 91, a single photo is shown. After unfolding the card 90 once, two photos are shown 92. After another unfolding, four photos are shown 93. When the card 90 is fully unfolded 94, eight photos are shown.

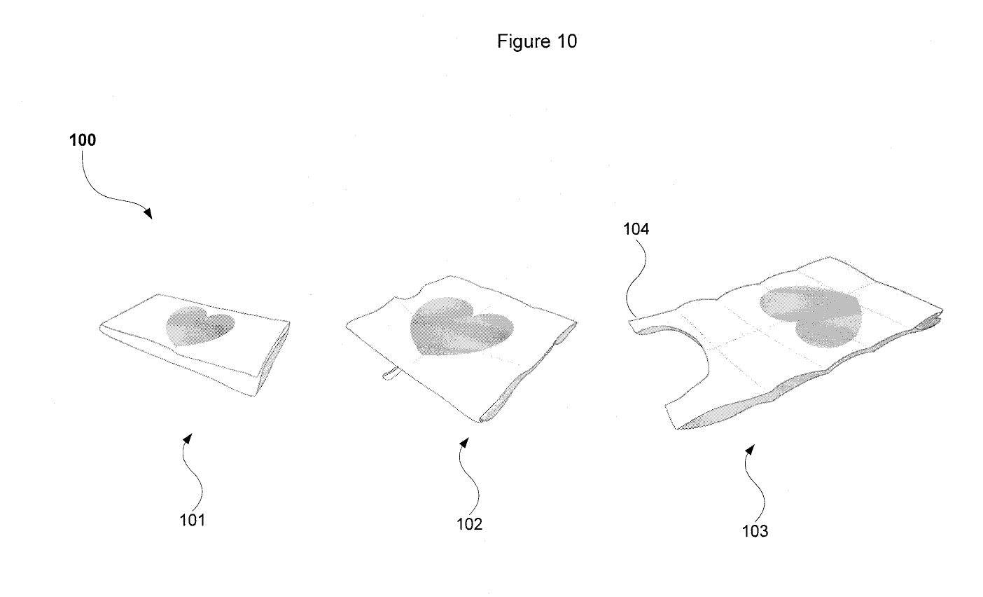

Referring to FIG. 10, another embodiment of the card 100 is depicted. The card 100 is made of fabric or fabric-like material and finally unfolds into a simple bag. The simple bag may be a library bag and used instead of a plastic bag for shopping to be environmentally friendly. Each section of the card has a greeting message. In the example illustrated, initially a heart is shown 101. Later after two unfolding steps, a larger heart is shown 102. After the final unfolding step, a similar sized heart is shown 103 and the handles 104 of the bag are revealed.

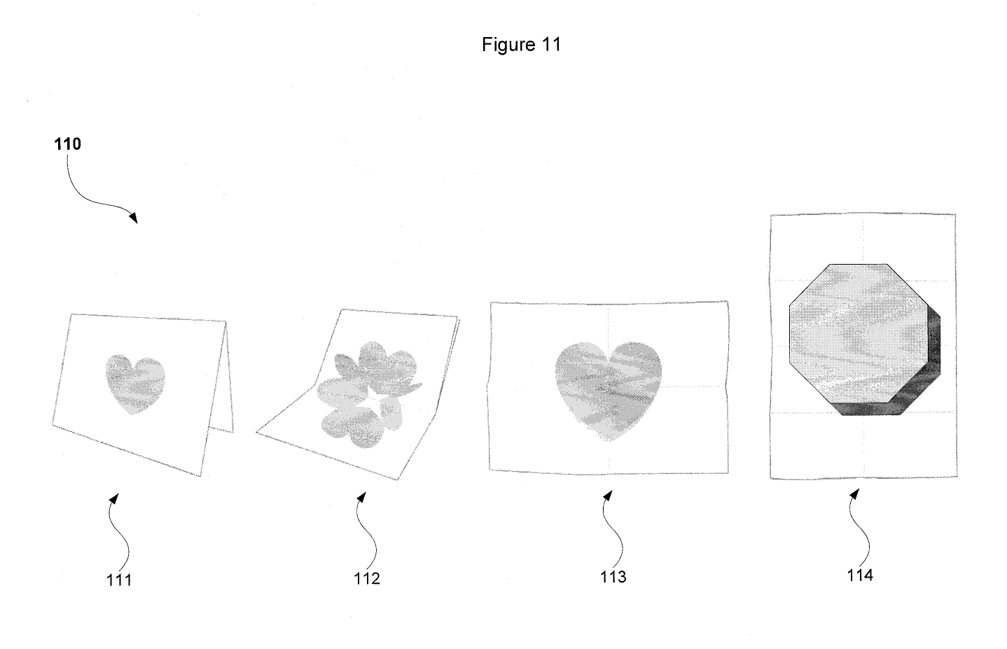

Referring to FIG. 11 another embodiment of the card 110 is depicted. The card 110 has certain pop up elements as it is unfolded. In the example illustrated, initially a heart is shown 111. After unfolding the card 110 once, a circular arrangement of hearts is shown 112. The circular arrangement of hearts are a pop-up element that are raised and lifted from the surface of the card 110. Other pop-up elements include shapes that are cut into the card 110 and cause a three dimensional effect. After the card 110 is unfolded again, a single heart is shown 113. The single heart is another pop-up element that is raised above the surface of the card 110. After the final unfolding step, another pop-up element is shown 114.

Although a single sheet of paper 20 has been described in some embodiments, it is envisaged that other paper products may be used or other materials with similar properties to paper may be used.

It will be appreciated by persons skilled in the art that numerous variations and/or modifications may be made to the invention as shown in the specific embodiments without departing from the scope or spirit of the invention as broadly described. The present embodiments are, therefore, to be considered in all respects illustrative and not restrictive.

We claim:

1. A foldable greeting card movable from a fully folded position to a fully unfolded position, comprising:
three longitudinal folds equally spaced apart;
a lateral fold intersecting the longitudinal folds to form eight card sections arranged in four columns and two rows, the card sections having a first side and a second side;
wherein on the first side of the card sections:
a card section at a second column of a second row is a front outer cover having a first greeting message when the card is in the fully folded position;
a card section at a first column of the second row is a rear outer cover when the card is in the fully folded position;
card sections at the first and second columns of the first row are exposed to present a second greeting message;
card sections at third and fourth columns of the first and second rows are exposed to present a third greeting message;
wherein on the second side of the card sections, all the card sections are exposed to present a fourth greeting message when the card is in the fully unfolded position.

2. The card according to claim 1, wherein the fourth greeting message is larger in size than the third greeting message, the third greeting message is larger in size than the second greeting message, and the second greeting message is larger in size than the first greeting message.

3. The card according to claim 1, wherein an expression of sentiment for the card may be any one from the group consisting of: birthday, anniversary, wedding, farewell, get well, congratulations, friendship, retirement, birth of baby, love, Valentine's day, humor, Christmas, graduation, and thank you.

4. The card according to claim 1, wherein the greeting messages are messages about a celebrity, and the fourth greeting message is a poster image of the celebrity.

5. The card according to claim 1, further comprising at least another lateral fold and/or at least another longitudinal fold to form at least sixteen card sections.

6. The card according to claim 1, wherein the card is in the form of a paper bag.

7. The card according to claim 1, further comprising transparent sleeves on each card section for receiving a photo.

8. The card according to claim 1, wherein the card is made of fabric and further comprises handles.

9. The card according to claim 1, further comprising pop up elements that are raised from the surface of the card.
